(19) United States
(12) Patent Application Publication
(10) Pub. No.: US 2026/0078266 A1
(43) Pub. Date: Mar. 19, 2026

(54) NON OR LOW-INTUMESCENT FIRE-RESISTANT COATINGS AND COATING COMPOSITIONS

(71) Applicant: AXALTA COATING SYSTEMS IP CO., LLC, Wilmington, DE (US)

(72) Inventors: Stephen Istivan, Havertown, PA (US); Gaurang Bhargava, Mount Laurel, NJ (US); Delson J. Trindade, Wilmington, DE (US); Ian Sullivan, Medford, NJ (US)

(73) Assignee: AXALTA COATING SYSTEMS IP CO., LLC, Wilmington, DE (US)

(21) Appl. No.: 19/302,985

(22) Filed: Aug. 18, 2025

Related U.S. Application Data
(60) Provisional application No. 63/694,326, filed on Sep. 13, 2024.

(51) Int. Cl. C09D 5/18; B05D 1/12; C08K 3/22; C08K 3/36; C08K 3/40; C08K 5/3492; C08K 7/10; C08K 7/28; C09D 7/40; C09D 7/43; C09D 7/61; C09D 175/12; C09D 183/04

(52) U.S. Cl. CPC C09D 5/18; B05D 1/12; C08K 3/36; C08K 3/40; C08K 5/34922; C08K 7/10; C08K 7/28; C09D 7/43; C09D 7/61; C09D 7/69; C09D 7/70; C09D 175/12; C09D 183/04; B05D 2401/20; B05D 2503/00; B05D 2518/12; B05D 2601/22; C08K 2003/2227; C08K 2201/005; C08K 2201/014; C08K 2201/016

(57) ABSTRACT

Non or low-intumescent fire-resistant coatings, coating compositions used to form the coatings, and composite articles including the coatings are provided herein. In an embodiment, a non or low-intumescent fire-resistant coating is formed from an aqueous coating composition comprising a polyurethane urea resin, a melamine crosslinker, a silicone resin, and a filler. The non or low-intumescent fire-resistant coating has a thermal conductivity of from about 0.03 W/m-K to about 0.1 W/m-K, as measured using a guarded hot plate apparatus in accordance with ASTM E1530. The coating expands by from about 0.1% to about 10% based on a total volume of the coating, after exposure to a propane flame at a distance of 26 mm from the coating and/or exposure to a temperature of about 1200° C. for a period of at least 10 minutes.

### CROSS-REFERENCE TO RELATED APPLICATIONS

This application claims the benefit of U.S. Provisional Application No. 63/694,326, filed Sep. 13, 2024.

### TECHNICAL FIELD

The present disclosure generally relates to coatings and aqueous coating compositions used to form the coatings. The present disclosure more particularly relates to non or low-intumescent fire-resistant coatings and aqueous coating compositions used to form the non or low-intumescent fire-resistant coatings.

### BACKGROUND

Industry has long strived to maximize fire resistance of various articles and devices, and to minimize the spread of fires within devices upon ignition. Fires may result from a variety of sources. For example, fires may occur in residential, commercial, or industrial settings as a result of an object becoming too hot, an open flame coming into contact with a combustible material, a flammable chemical coming into contact with oxygen, or a faulty electrical system experiencing short circuits or electrical arcs.

One example of an article that may pose a fire risk is a battery. Battery chemistry stores a significant amount of energy. This is an advantage for battery performance but may give rise to safety and fire concerns. A charged battery contains both fuel and oxidizer, the combination of which is flammable and potentially explosive under circumstances where the battery is damaged. If a large battery or a large quantity of batteries are involved in a battery fire, the results can be catastrophic and such fires are often difficult to control or contain.

In order to mitigate the spread of battery fires, fire-resistant coatings have been developed that are intended for surfaces within or in proximity to the battery. Desirable fire-resistant coatings generally exhibit low thermal conductivity, and they are capable of withstanding exposure to targeted high temperatures for a predetermined period of time, depending upon the particular environment of intended use. Many existing fire-resistant coatings are generally intumescent, meaning that they expand in response to heat exposure, increasing in volume and decreasing in density. The increased volume and decreased density slows the spread of flame and excessive heat.

In some modern applications, such as in batteries housed inside electric vehicles, components are tightly packed and positioned in close proximity to each other. In such applications, there is minimal space for an intumescent fire-resistant coating to adequately expand. To account for this, some non or low-intumescent fire-resistant coatings exist. However, these existing non or low-intumescent fire-resistant coatings may not perform as well as intumescent fire-resistant coatings. For example, existing non or low-intumescent fire-resistant coatings often exhibit a thermal conductivity which may be too high for the coatings to effectively slow the spread of flame and excessive heat.

Accordingly, it is desirable to develop a fire-resistant coating that exhibits minimized thermal expansion, while maintaining a minimized thermal conductivity, in order to inhibit fire risk and slow the spread of flame and excessive heat, even when exposed to heat or flame for a prolonged period of time. Furthermore, other desirable features and characteristics of the present disclosure will become apparent from the subsequent detailed description and the appended claims, taken in conjunction with the accompanying drawings and this background.

### BRIEF SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Non or low-intumescent fire-resistant coatings, coating compositions used to form the coatings, composite articles including the coatings, and methods of forming the composite articles are provided herein. In an embodiment, a non or low-intumescent fire-resistant coating is formed from an aqueous coating composition comprising a polyurethane urea resin, a melamine crosslinker, a silicone resin, and a filler. The non or low-intumescent fire-resistant coating has a thermal conductivity of from about 0.03 W/m-K to about 0.1 W/m-K, as measured using a guarded hot plate apparatus in accordance with ASTM E1530. The non or low-intumescent fire-resistant coating expands by from about 0.1% to about 10%, based on a total volume of the coating, when exposed to a propane flame at a distance of 26 mm from the coating and/or exposure to a temperature of about 1200° C. for a period of at least 10 minutes.

### DETAILED DESCRIPTION

The following detailed description is merely exemplary in nature and is not intended to limit the present disclosure or the application and uses thereof. Furthermore, there is no intention to be bound by any theory presented in the preceding background or the following detailed description.

Non or low-intumescent fire-resistant coatings and aqueous coating compositions used to form the coatings are provided herein. The non or low-intumescent fire-resistant coatings exhibit minimized thermal expansion and maintain a minimized thermal conductivity both before and after exposure to heat or flame for a prolonged period of time. Specifically, the non or low-intumescent fire-resistant coatings, which are cured films of the coating compositions provided herein, expand by from about 0.1% to about 10%, based on a total volume of the coating, when exposed to a propane flame at a distance of 26 mm from the coating and/or when exposed to a temperature of about 1200° C. for a period of at least 10 minutes. The minimized thermal expansion allows the coating compositions to be used in applications with limited space for expansion when exposed to flame, such as in a vehicle battery assembly. Further, the non or low-intumescent fire-resistant coatings provided herein have a thermal conductivity of from about 0.03 W/m-K to about 0.1 W/m-K, as measured using a guarded hot plate apparatus in accordance with ASTM E1530. The minimized thermal conductivity provides fire protection by adequately inhibiting the spread of heat and flame. The advantageous performance of the non or low-intumescent fire-resistant coatings provided herein are achieved by forming the coatings from an aqueous coating composition that includes a polyurethane urea resin, a melamine crosslinker, a silicone resin, and a filler.

Unless specifically stated or obvious from context, as used herein, the term “about” is understood as within a range of normal tolerance in the art measured using standard measurement devices for a given measurement, for example within 2 standard deviations of the mean for a particular measurement device. “About” can be understood as within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

As used herein, “nominal dimension” refers to a reference dimension of a particle. If the particle is a sphere, then the nominal dimension is defined as the diameter of the spherical particle. If the particle is not a sphere, then the nominal dimension is defined as the largest dimension of the particle.

As used herein, the “average nominal particle dimension” or “D50 nominal particle dimension” refers to a measurement below which the nominal dimension of 50% of the particles by volume in the population falls. As described herein, D50 nominal particle dimensions are measured using a sieve in accordance with ASTM 5861-07 (2017).

As used herein, “solids content” refers to the percent, by weight, of non-volatile components that would remain after any solvents and/or volatile components are removed from a resin or composition, based on a total weight of the resin or composition.

The aqueous coating compositions provided herein are used to form the non or low-intumescent fire-resistant coatings provided herein. The polyurethane urea resin is provided in the aqueous coating composition to improve flexibility of the coating before the coating is exposed to heat or fire. Flexibility is important in applications where the coating may move or bend. The more flexible the coating, the less prone it is to cracking or breaking, which may leave gaps in the coating, exposing an underlying substrate to fire risk. The polyurethane urea resin is also provided as a component that reacts upon curing to form a substantially crosslinked thermoset polymer film. Free hydroxyl groups and/or amine groups in the polyurethane urea resin are capable of reacting, under certain conditions, to form crosslinks. The crosslinks contribute to the setting up of the aqueous coating composition to form the coating.

In embodiments, the polyurethane urea resin is formed by the reaction of a diisocyanate with a polyol and a polyamine. As used herein, “polyol” and “polyamine” refer to compounds having more than one of the specified functional group (alcohol and amine, respectively). This would include a diol or diamine, a triol or triamine, a tetrol or tetramine, etc. In embodiments, the diisocyanate is selected from aromatic diisocyanates such as toluene diisocyanate or methylene diphenyl diisocyanate; aliphatic diisocyanates such as hexamethylene diisocyanate; alicyclic diisocyanates such as methyelene bis cyclohexylisocyanate or isophorone diisocyanate; and combinations thereof. In embodiments, the polyol is selected from a polyether polyol, a polyester polyol, a polycarbonate polyol, a polybutadiene polyol, a polycaprolactone polyol, an acrylic polyol, and combinations thereof. In embodiments, the polyamine is selected from aliphatic polyamines such as ethylene diamine or hexamethylene diamine; aromatic polyamines such as 2,4-toluene diamine or 4,4′-methylenedianiline; alicyclic polyamines such as 1,2-diaminocyclohexane or isophorone diamine; polyether polyamines; polyester polyamines; and combinations thereof. In embodiments, the polyurethane urea resin is a polyester urea resin or a polyether urea resin. In embodiments, the polyurethane urea resin may be supplied to the aqueous coating composition in the form of an aqueous dispersion. In embodiments, the aqueous dispersion may have a solids content of from about 10 wt % to about 60 wt %, alternatively from about 20 wt % to about 50 wt %, based on a total weight of the aqueous dispersion.

In embodiments, the polyurethane urea resin may be present in the aqueous coating composition in an amount of from about 10 wt % to about 50 wt %, alternatively from about 10 wt % to about 40 wt %, alternatively from about 15 wt % to about 30 wt %, based on a total weight of the aqueous coating composition.

The melamine crosslinker is provided in the aqueous coating composition to facilitate crosslinking of the polyurethane urea resin. The presence of the melamine crosslinker in the aqueous coating composition may contribute to the hardness and chemical resistance of the non or low-intumescent fire-resistant coating. The melamine crosslinker may be selected from methylated melamine, butylated melamine, melamine formaldehyde, and combinations thereof. In embodiments, the melamine crosslinker is a methylated melamine formaldehyde resin. In embodiments, the melamine crosslinker may be supplied to the aqueous coating composition in a solution having a solids content of from about 70 wt % to about 90 wt %, alternatively from about 75 wt % to about 85 wt %. In embodiments, the solution may contain a solvent selected from water, methanol, ethanol, iso-propanol or n-propanol, iso-butanol or n-butanol, ethyl acetate, butyl acetate, ethylene glycol monobutyl ether, and combinations thereof.

In embodiments, the melamine crosslinker may be present in the aqueous coating composition in an amount of from about 1 wt % to about 20 wt %, alternatively from about 1 wt % to about 10 wt %, alternatively from about 1 wt % to about 5 wt %, based on a total weight of the aqueous coating composition.

The silicone resin is provided in the aqueous coating composition to improve flexibility of the coating during and/or after exposure to fire and/or heat. The silicone resin may also contribute to electrical insulation (i.e. maximized dielectric breakdown voltage) and thermal insulation (i.e. resistance to changes in temperature when exposed to a flame or a high temperature environment) of the coating. As used herein, “silicone resin” refers to a synthetic polymer having a backbone of alternating silicon and oxygen atoms, with organic groups attached to at least some of the silicon atoms. In embodiments, the silicone resin may be selected from methyl silicone resins, phenyl silicone resins, vinyl silicone resins, epoxy functional silicone resins, acrylic functional silicone resins, amine functional silicone resins, siloxane resins, alkoxy functional silicone resins, and combinations thereof. In embodiments, the silicone resin may be supplied to the aqueous coating composition in the form of a water-based emulsion. In embodiments, the emulsion may have a solids content of from about 30 wt % to about 70 wt %, alternatively from about 40 wt % to about 60 wt %, based on a total weight of the emulsion.

In embodiments, the silicone resin may be present in the aqueous coating composition in an amount of from about 10 wt % to about 50 wt %, alternatively from about 10 wt % to about 40 wt %, alternatively from about 20 wt % to about 35 wt %, based on a total weight of the aqueous coating composition. In embodiments, the weight ratio of the silicone resin to the polyurethane urea resin in the aqueous coating composition is from about 1:3 to about 3:1, alternatively from about 1:1 to about 3:1.

The filler is provided in the aqueous coating composition for a variety of purposes. For example, the filler may contribute to thermal and electrical insulation of the coating, light weight of the aqueous coating composition, physical properties of the coating such as hardness and flexibility, cohesiveness of the coating (i.e. resistance to cracking or falling apart), appearance of the coating, sprayability of the aqueous coating composition (e.g. dynamic viscosity), and/or shelf stability of the aqueous coating composition. As used herein, “filler” refers to all inorganic particulate components within the coating composition. The aqueous coating composition may contain only one filler, or alternatively, the aqueous coating composition may contain more than one filler. In embodiments, the aqueous coating composition contains at least two fillers, alternatively at least three fillers.

In embodiments, the filler comprises a porous glass aggregate. As used herein, “glass” refers to a non-crystalline, amorphous material. The porous glass aggregate may contribute to the light weight and fire resistance of the coating. In embodiments, the porous glass aggregate may be chosen from sodium carbonate, borosilicate, lead oxide, aluminosilicate, barium oxide, thorium oxide, iron oxide, cerium oxide, or combinations thereof. In embodiments, the porous glass aggregate may be formed from recycled glass. In embodiments, the porous glass aggregate has a D50 nominal particle dimension of from about 0.05 mm to about 4.5 mm, alternatively from about 0.05 mm to about 2.4 mm, alternatively from about 0.3 mm to about 1.2 mm, as measured using a sieve in accordance with ASTM 5861-07 (2017). In embodiments, the porous glass aggregate may have a bulk density of from about 15 lb/ft³ to about 50 lb/ft³, alternatively from about 20 lb/ft³ to about 40 lb/ft³, alternatively from about 20 lb/ft³ to about 30 lb/ft³, as measured in accordance with ASTM C29. In embodiments, the porous glass aggregate may be present in the aqueous coating composition in an amount of from about 10 wt % to about 30 wt %, alternatively from about 15 wt % to about 25 wt %, based on a total weight of the aqueous coating composition.

In embodiments, the filler comprises a non-glass filler. As used herein, “non-glass” refers to a material having a crystalline structure. The non-glass filler may be chosen from a mineral fiber, a non-fiber mineral component, and combinations thereof. In embodiments, the non-glass filler is a mineral fiber. The mineral fiber may contribute to the cohesiveness and flexibility of the coating (e.g. resistance to cracking). As used herein, “mineral fiber” refers to a particulate comprising a metal oxide and/or metalloid oxide and having an average aspect ratio of from about 50 to about 200, as determined in accordance with ISO 9276-6 (2008). In embodiments, the mineral fiber comprises iron oxide, aluminum oxide, tin oxide, copper oxide, zinc oxide, manganese oxide, titanium dioxide, magnesium oxide, chromium oxide, silicon dioxide, calcium oxide, sodium oxide, potassium oxide, phosphorous oxide, or combinations thereof. In embodiments, the mineral fiber has a D50 nominal particle dimension of from about 20 microns to about 500 microns, alternatively from about 50 microns to about 400 microns, alternatively from about 200 microns to about 400 microns, as measured using a sieve in accordance with ASTM 5861-07 (2017). In embodiments, the mineral fiber may be present in the aqueous coating composition in an amount of from about 1 wt % to about 10 wt %, alternatively from about 2 wt % to about 9 wt %, alternatively from about 3 wt % to about 7 wt %, based on a total weight of the aqueous coating composition.

In embodiments, the non-glass filler is a non-fiber mineral component. As used herein, “non-fiber mineral component” refers to a particulate comprising a metal oxide and/or metalloid oxide and having an average aspect ratio of from about 1 to about 10, as determined in accordance with ISO 9276-6 (2008). In embodiments, the non-fiber mineral component is chosen from iron oxide, aluminum oxide, tin oxide, copper oxide, zinc oxide, manganese oxide, titanium dioxide, magnesium oxide, chromium oxide, silicon dioxide, calcium oxide, sodium oxide, potassium oxide, phosphorous oxide, or combinations thereof. In embodiments, the non-fiber mineral component has a D50 nominal particle dimension of from about 0.01 microns to about 1000 microns, alternatively from about 10 microns to about 500 microns, as measured using a sieve in accordance with ASTM 5861-07 (2017). In embodiments, the non-fiber mineral component may be present in the aqueous coating composition in an amount of from about 1 wt % to about 10 wt %, alternatively from about 2 wt % to about 9 wt %, alternatively from about 3 wt % to about 7 wt %, based on a total weight of the aqueous coating composition.

In embodiments, the filler comprises a combination of the porous glass aggregate and the non-glass filler. The combination of fillers in the aqueous coating composition leads to a coating that is light weight and provides fire protection without becoming brittle and/or falling apart. The porous glass aggregate has a lower bulk density than the non-glass filler. The minimized bulk density of the porous glass aggregate contributes to a minimized weight and maximized fire-resistance of the aqueous coating composition and the resulting coating. However, in the absence of a non-glass filler, the resulting coating may become brittle and crack or fall apart, especially in the presence of heat or flame. The non-glass filler contributes to the cohesiveness of the coating (i.e. resistance to cracking or falling apart). In embodiments, the weight ratio of the porous glass aggregate to the non-glass filler is from about 2:1 to about 10:1, alternatively from about 2:1 to about 8:1, alternatively from about 2:1 to about 6:1, alternatively from about 3:1 to about 5:1.

In embodiments, the aqueous coating composition further comprises a pH stabilizing agent to help stabilize the pH of the aqueous coating composition and improve the shelf stability of the aqueous coating composition. The pH stabilizing agent may be selected from alkanolamines, phosphates, hydroxides, carbonates, bicarbonates, or combinations thereof. In embodiments, the pH stabilizing agent is an alkanol amine such as dimethyl ethanol amine, diethyl ethanol amine, or aminomethyl propanol. In embodiments, the pH stabilizing agent may be present in the aqueous coating composition in an amount of from about 0.1 wt % to about 2.0 wt %, alternatively from about 0.1 wt % to about 1.0 wt %, based on a total weight of the aqueous coating composition.

In embodiments, the aqueous coating composition further comprises a rheology modifier. The rheology modifier may be chosen from a surfactant, a thickener, and combinations thereof. The rheology modifier may affect the flow properties, such as the Krebs viscosity, of the aqueous coating composition. The rheology modifier may improve the sprayability and/or pumpability of the aqueous coating composition.

In embodiments, the aqueous coating composition comprises water in an amount of from about 5 wt % to about 30 wt %, alternatively from about 10 wt % to about 20 wt %. The water may be deionized water.

In embodiments, the pH of the aqueous coating composition is from about 7.0 to about 10.0, alternatively from about 8.0 to about 9.5, alternatively from about 8.5 to about 9.0. The recited pH ranges contribute to maximized shelf stability of the aqueous coating composition. Specifically, when the pH of the aqueous coating composition is within the recited ranges, the Krebs viscosity of the aqueous coating composition remains within a desired range for a longer period of time than when the pH of the aqueous coating composition is outside of the recited ranges.

In embodiments, the aqueous coating composition has a Krebs viscosity of from about 120 Krebs units to about 240 Krebs units, as measured in accordance with ASTM D562-10 using a Krebs Stormer type viscometer with a paddle spindle rotating at 200 RPM at a temperature of 25° C. When the Krebs viscosity of the aqueous coating composition is within the recited viscosity range, the aqueous coating composition may be sprayable using gravity fed spray equipment and/or pressure fed spray equipment, allowing for efficient application of the aqueous coating composition to a substrate. If the Krebs viscosity of the aqueous coating composition is above the recited range, the aqueous coating composition may not be sprayable or pumpable, limiting the available application methods and creating the potential for poor coverage. If the Krebs viscosity of the aqueous coating composition is below the recited range, the aqueous coating composition may drip or sag after application to a substrate and may exhibit popping during the curing process, leading to defects in the resulting cured coating. Poor coverage and/or defects in the coating may leave the substrate exposed to heat or flame, reducing the effectiveness of the coating's fire-resistance.

In embodiments, the aqueous coating composition is a 1k composition. As used herein, a “1k composition” is defined as a single package system wherein all elements of the coating composition are included in one package, and the coating composition cures upon exposure to certain conditions. When a 1k coating composition is stored in a can or other closed container, hydroxyl-reactive and/or amine-reactive functional groups of the crosslinking agent do not react with the free hydroxyl groups and/or amine groups in the polyurethane urea resin. This allows the coating composition to remain in the can without curing. However, upon exposure to certain conditions, including heat, hydroxyl-reactive and/or amine reactive functional groups of the crosslinking agent react with the free hydroxyl groups and/or amine groups in the polyurethane urea resin, causing crosslinking of the resin and curing of the coating composition to form a film. In embodiments, the aqueous coating composition is a 2k composition. As used herein, a “2k composition” is defined as a two package system wherein elements of the coating composition are included in two separate packages, and the two packages are combined before application of the coating composition, which cures upon combination and/or upon exposure to certain conditions.

The non or low-intumescent fire-resistant coatings provided herein have a thermal conductivity of from about 0.03 W/m-K to about 0.1 W/m-K, as measured using a guarded hot plate apparatus in accordance with ASTM E1530. The recited thermal conductivity values result at least in part from the combination of the porous glass aggregate and the non-glass filler in the aqueous coating composition. The recited range of thermal conductivity makes the coatings effective heat insulators that slow down the transfer of heat through the coating. This helps delay the spread of heat and fire from the environment to an underlying substrate and/or any materials that may be housed within the coating. For example, if the coating is used on a battery housing, the minimized thermal conductivity of the coating may inhibit exposure of the underlying battery to heat and flame, making it less likely that hazardous materials inside the battery will start on fire.

The non or low-intumescent fire-resistant coatings provided herein expand by from about 0.1% to about 10%, based on a total volume of the coating, when exposed to a propane flame at a distance of 26 mm from the coating and/or when exposed to a temperature of about 1200° C. for a period of at least 10 minutes, alternatively at least 60 minutes, alternatively at least 120 minutes. The recited thermal expansion under the given conditions allows the coating to be used in applications where the coating does not have space to expand, such as on a battery housing in a vehicle. The combination of the minimized thermal expansion and the minimized thermal conductivity in a coating has previously been difficult to achieve.

In embodiments, the non or low-intumescent fire-resistant coatings provided herein have a dielectric breakdown voltage, as measured using the Short-Time Test (Method A) in accordance with ASTM D149-20, of from about 6 kV to about 15 kV before exposure to fire, and from about 2.5 kV to about 15 kV after exposure to a propane flame at a distance of 26 mm from the coating and/or exposure to a temperature of about 1200° C. for a period of at least 10 minutes, alternatively at least 60 minutes, alternatively at least 120 minutes. The dielectric breakdown voltage represents the voltage at which the electrically insulative coating fails to prevent the flow of current and becomes electrically conductive. The maximized dielectric breakdown voltage of the coatings provided herein inhibits dielectric breakdown, thus reducing the risk of electricity flowing through the coating and contacting an underlying substrate. Inhibition of electrical flow through the coating may be particularly important when the coating is used in an application such as a battery housing.

The composite articles provided herein comprise a substrate and the non or low-intumescent fire-resistant coating provided herein, bonded to the substrate. The substrate is provided as the surface or object that requires fire protection. The substrate may be chosen from a variety of materials such as metal, plastic, glass, or wood. In embodiments, the substrate is chosen from metal, plastic, or combinations thereof. In embodiments, the substrate may have a thickness of from about 0.5 mm to about 5 mm, alternatively from about 0.5 mm to about 2.5 mm. The substrate may be an object or surface such as a structural wall, a kitchen appliance, an automotive part, or an article of clothing. In embodiments, the substrate is a battery housing. The battery housing may be used for, for example, a battery in an electrical vehicle. In embodiments, the coating on the composite article has a thickness of from about 0.5 mm to about 3.0 mm, alternatively from about 0.5 mm to about 2.0 mm, alternatively from about 0.5 mm to about 1.0 mm.

In embodiments, the composite article further comprises an additional layer disposed between the substrate and the coating. The composite article may comprise only one additional layer, or alternatively, the composite article may comprise more than one additional layer. In embodiments, the additional layer may be a coating different from the non or low-intumescent fire-resistant coating. For example, the additional layer may be an electrocoating, a primer layer, an additional fire-resistant coating different from the non or low-intumescent fire resistant coating provided herein, or another type of layer. In embodiments, the additional layer has a thickness of from about 5 μm to about 3.0 mm, alternatively from about 10 μm to about 1.0 mm, alternatively from about 10 μm to about 100 μm.

In embodiments, when the non or low-intumescent fire-resistant coating has a thickness of about 2 mm and when a temperature of the substrate is about 25° C. before exposure to heat or flame, the temperature of the substrate increases to no more than about 400° C., alternatively no more than about 350° C., as measured using a K-type thermocouple in direct contact with the substrate on a side of the substrate opposite the coating, when the composite article is exposed to a propane flame at a distance of 26 mm from the coating and/or when the composite article is exposed to a temperature of about 1200° C. for a period of at least 10 minutes, alternatively at least 60 minutes, alternatively at least 120 minutes. The minimized temperature of the substrate after exposure to heat and/or flame minimizes the risk of the substrate catching on fire or sustaining damage due to unacceptably high temperatures. The minimized change in temperature of the substrate is related to the minimized thermal conductivity of the coating.

In embodiments, the coating in the composite article demonstrates no cracking, as determined by visual observation at a distance of 3 feet from the composite article in a room with standard lighting, when the composite article is folded at 90 degrees, both before and after exposure to a propane flame at a distance of 26 mm from the coating and/or exposure to a temperature of about 1200° C. for a period of at least 10 minutes. Absence of cracking in the coating protects the underlying substrate from fire exposure and damage, and contributes to the aesthetic appeal and durability of the composite article.

The methods provided herein are directed to forming the composite articles provided herein. The methods comprise applying the coating composition provided herein to a substrate to form a film, and curing the film. Applying the coating composition may comprise spraying the coating composition onto the substrate, dipping the substrate into the coating composition, rolling the coating composition onto the substrate, and/or spackling the coating composition onto the substrate. In embodiments, applying the coating composition comprises spraying the coating composition using gravity fed spray equipment and/or pressure fed spray equipment. Applying the coating composition using gravity fed spray equipment and/or pressure fed spray equipment allows for effective handling and application of the coating composition, and is possible at least in part because of the viscosity of the coating composition, as described above. Curing the film may comprise applying heat to the film. In embodiments, the film may be exposed to a temperature of from about 100° C. to about 240° C., alternatively from about 140° C. to about 200° C., for a period of from about 5 minutes to about 60 minutes, alternatively from about 15 minutes to about 45 minutes.

### EXAMPLES

### Examples 1-14

The composite articles of Examples 1-14 were prepared by obtaining cold rolled steel panels commercially electrocoated (E-coated) with AquaEC™ 4027 electrocoating (electrocoating commercially available from Axalta Coating Systems LLC; coated panels commercially available from ACT Test Panels LLC). The thickness of the steel panels was 2 mm, and the thickness of the electrocoating was 20 μm. Then, the substrates were coated with Raptor® Flameproof coating composition, commercially available from U-POL Ltd., by spraying the coating composition onto the electrocoated panels by hand to form a layer having a thickness of about 50 μm, and then curing the resulting coating at a temperature of 80° C. Then a non or low-intumescent fire resistant coating composition in accordance with this disclosure (designated Coating 1) was applied by spraying the composition of Coating 1 onto the substrate by hand to form a layer having a thickness of about 1.5 mm. The resulting Coating 1 layer was cured at a temperature of 140° C. The general composition of Coating 1 is shown below in Table 1.

TABLE 1
Composition of “Coating 1”

| Component | Coating 1 (wt %) |
|---|---|
| Silicone Resin | 20-35% |
| Polyurethane Urea Resin | 15-30% |
| pH Stabilizing Agent | 0.1-1% |
| Deionized Water | 10-20% |
| Melamine Crosslinker | 1-5% |
| Mineral Fiber | 0-7% |
| Non-Fiber Mineral | 3-7% |
| Component | |
| Porous Glass Aggregate | 0-25% |
| Other Additives | 0.5-5% |

In Table 1, the percentages are weight percentages of each component, based on a total weight of the coating composition.

The pH stabilizing agent is dimethyl ethanol amine.

The melamine crosslinker is methylated high imino melamine crosslinker supplied in iso-butanol, commercially available from Allnex Coating Resins Company.

The mineral fiber has an average aspect ratio of from about 100 to about 120, as determined in accordance with ISO 9276-6 (2008). The mineral fiber comprises silicon dioxide and aluminum oxide.

The non-fiber mineral component is silica having a D50 nominal particle dimension of about 300 μm, as measured using a sieve in accordance with ASTM 5861-07 (2017).

The porous glass aggregate has a D50 nominal particle dimension of from about 0.30 mm to about 1.2 mm, as measured using a sieve in accordance with ASTM 5861-07 (2017).

The other additives include a thickener.

Variations on Coating 1 used in each of Examples 1-14 are shown below in Table 2.

TABLE 2
Variations on Coating 1 for Examples 1-14

| | Weight Ratio of Silicone | Amount of | Mineral | Amount of Porous |
|---|---|---|---|---|
| | Resin to Polyurethane | Mineral Fiber | Fiber Size | Glass Aggregate |
| Example | Urea Resin | (wt %) | (microns) | (wt %) |
| Example 1 | 1:2 | 0% | N/A | 0% |
| Example 2 | 2:1 | 0% | N/A | 0% |
| Example 3 | 2:1 | 2% | 50 | 0% |
| Example 4 | 2:1 | 5% | 50 | 0% |
| Example 5 | 2:1 | 8% | 50 | 0% |
| Example 6 | 2:1 | 5% | 50 | 10% |
| Example 7 | 2:1 | 5% | 50 | 20% |
| Example 8 | 2:1 | 5% | 50 | 30% |
| Example 9 | 2:1 | 2% | 300 | 0% |
| Example 10 | 2:1 | 5% | 300 | 0% |
| Example 11 | 2:1 | 8% | 300 | 0% |
| Example 12 | 2:1 | 5% | 300 | 10% |
| Example 13 | 2:1 | 5% | 300 | 20% |
| Example 14 | 2:1 | 5% | 300 | 30% |

In Table 2, the percentages are weight percentages of the designated component, based on a total weight of the coating composition.

The mineral fiber size is the D50 nominal particle dimension in microns, as measured using a sieve in accordance with ASTM 5861-07 (2017).

### Comparative Examples 1-2

Comparative Examples 1-2 are comparative examples not in accordance with this disclosure. For Comparative Examples 1-2, the procedure described above for Examples 1-14 was followed, except that the composition of Coating 1 was modified. For Comparative Example 1 and Comparative Example 2, the Coating 1 contained no mineral fiber and no porous glass aggregate. Notably, the modified Coating 1 of Comparative Example 1 contained no silicone resin, and the modified Coating 1 of Comparative Example 2 contained no polyurethane urea resin.

Each of the composite articles for Examples 1-14 and Comparative Examples 1-2 started out at a temperature of about 25° C., and then were subjected to a propane flame creating an environment temperature of about 1200° C.

For the coated panels of Examples 1-14 and Comparative Examples 1-2, testing was conducted to determine the dielectric breakdown voltage, film delamination or damage, the flammability, the film flexibility, and the temperature of the coated panel when exposed to heat or flame.

The dielectric breakdown voltage of each coated panel was measured using the Short-Time Test (Method A) in accordance with ASTM D149-20. The dielectric breakdown voltage of the coated panels was measured before the coated panels were exposed to the propane flame.

The presence of cracking after flame exposure was measured by visual observation at a distance of 3 feet from the coated panel in a room with standard lighting.

The flammability was tested by observing how long it took for a flame on the coated panel to extinguish, following UL-94 testing protocols.

The coating flexibility was measured by folding the coated panel at an angle of 90 degrees, and then visually observing the folded panel at a distance of 3 feet from the coated panel in a room with standard lighting. The coating flexibility was measured both before and after flame exposure.

The temperature increase of the coated panel during the period of flame exposure was measured by a K-type thermocouple in direct contact with the coated panel on a side of the coated panel opposite the flame. The temperature of the coated panel started at about 25° C. The temperature was monitored over the 10 minute period of flame exposure, and the final temperature was recorded. The results are shown in Table 4 Below.

TABLE 4
Results for Examples 10-14 and Comparative Examples 1-2

| | Dielectric | Film | | | Back |
|---|---|---|---|---|---|
| | Breakdown | Delamination | | | Panel |
| Example | Voltage | or Damage | Flammability | Flexibility | Temperature |
| Example 1 | 2 | 1 | 1 | 3 | 1 |
| Example 2 | 2 | 1 | 2 | 3 | 1 |
| Example 3 | 2 | 1 | 2 | 3 | 1 |
| Example 4 | 2 | 2 | 2 | 3 | 1 |
| Example 5 | 2 | 2 | 2 | 3 | 1 |
| Example 6 | 3 | 1 | 3 | 3 | 2 |
| Example 7 | 3 | 2 | 3 | 3 | 3 |
| Example 8 | 3 | 2 | 3 | 2 | 3 |
| Example 9 | 2 | 2 | 2 | 3 | 1 |
| Example 10 | 2 | 3 | 2 | 3 | 1 |
| Example 11 | 2 | 3 | 2 | 3 | 1 |
| Example 12 | 3 | 3 | 2 | 3 | 2 |
| Example 13 | 3 | 3 | 3 | 3 | 3 |
| Example 14 | 3 | 3 | 3 | 1 | 3 |
| Comparative | 2 | 1 | 1 | 3 | 1 |
| Example 1 | | | | | |
| Comparative | 2 | 1 | 2 | 2 | 1 |
| Example 2 | | | | | |

In Table 4, a score of “1” represents poor performance, a score of “2” represents marginal performance, and a score of “3” represents excellent performance. Specifically, for the dielectric breakdown voltage, a score of “1” means that the value of the dielectric breakdown voltage was less than 3 kV, a score of “2” means that the value of the dielectric breakdown voltage was from 3 kV to 6 kV, and a score of “3” means that the dielectric breakdown voltage was greater than 6 kV.

For the film delamination or damage, a score of “1” means that the layer formed from Coating 1 partially or fully delaminated from the panel after flame exposure. A score of “2” means that the layer formed from Coating 1 showed damage (e.g. cracking) after flame exposure, but did not delaminate from the panel. A score of “3” means that no damage or delamination was observed after flame exposure.

For the flammability, a score of “1” means that it took more than 20 seconds for the flame on the panel to go out. A score of “2” means that it took less than 20 seconds but more than 10 seconds for the flame on the panel to go out. A score of “3” means that it took less than 10 seconds for the flame on the panel to go out.

For the flexibility, a score of “1” means that cracking was observed in the layer formed from Coating 1 when folded at 90 degrees both before flame exposure and after flame exposure. A score of “2” means that cracking was observed in the layer formed from Coating 1 when folded at 90 degrees after flame exposure but not before flame exposure. A score of “3” means that no cracking was observed in the layer formed from Coating 1 when folded at 90 degrees both before and after flame exposure.

For the back panel temperature, a score of “1” means that the side of the coated panel opposite the flame had a measured temperature of greater than 400° C. after flame exposure. A score of “2” means that the side of the coated panel opposite the flame had a measured temperature of from 350° C. to 400° C. after flame exposure. A score of “3” means that the side of the coated panel opposite the flame had a measured temperature of less than 350° C. after flame exposure.

The results show that Example 13 exhibited excellent performance for all measured parameters. Comparative Examples 1-2, which are not in accordance with this disclosure, exhibited poor performance for at least two of the measured parameters.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment of the present disclosure. It being understood that various changes may be made in the function and arrangement of elements described in an exemplary embodiment without departing from the scope of the present disclosure as set forth in the appended claims.

What is claimed is:

1. A non or low-intumescent fire-resistant coating formed from an aqueous coating composition comprising:
a polyurethane urea resin;
a melamine crosslinker;
a silicone resin; and
a filler;
wherein the non or low-intumescent fire-resistant coating has a thermal conductivity of from about 0.03 W/m-K to about 0.1 W/m-K, as measured using a guarded hot plate apparatus in accordance with ASTM E1530;
wherein the non or low-intumescent fire-resistant coating expands by from about 0.1% to about 10%, based on a total volume of the coating, when exposed to a propane flame at a distance of 26 mm from the coating and/or when exposed to a temperature of about 1200° C. for a period of at least 10 minutes.

2. The non or low-intumescent fire-resistant coating of claim 1, having a dielectric breakdown voltage, as measured using the Short-Time Test (Method A) in accordance with ASTM D149-20, of from about 6 kV to about 15 kV before exposure to fire, and from about 2.5 kV to about 15 kV after exposure to a propane flame at a distance of 26 mm from the coating and/or exposure to a temperature of about 1200° C. for a period of at least 10 minutes.

3. The non or low-intumescent fire-resistant coating of claim 1, wherein the filler comprises a porous glass aggregate.

4. The non or low-intumescent fire-resistant coating of claim 1, wherein the filler comprises silicon dioxide.

5. The non or low-intumescent fire-resistant coating of claim 3, wherein the filler further comprises a mineral fiber.

6. The non or low-intumescent fire-resistant coating of claim 1, wherein the aqueous coating composition further comprises a surfactant.

7. A composite article comprising:
a substrate; and
the non or low-intumescent fire-resistant coating of claim 1, bonded to the substrate.

8. The composite article of claim 7, wherein the coating has a thickness of from about 0.5 mm to about 3.0 mm.

9. The composite article of claim 7, further comprising an additional layer disposed between the substrate and the coating.

10. The composite article of claim 7, wherein the composite article is a battery housing.

11. The composite article of claim 7, wherein, when the non or low-intumescent fire-resistant coating has a thickness of about 2 mm and when a temperature of the substrate is about 25° C. before exposure to heat or flame, the temperature of the substrate increases to no more than about 400° C., as measured using a thermocouple in direct contact with the substrate on a side of the substrate opposite the coating, when exposed to a propane flame at a distance of 26 mm from the coating and/or when exposed to a temperature of about 1200° C. for a period of at least 10 minutes.

12. The composite article of claim 7, wherein the coating demonstrates no cracking, as determined by visual observation at a distance of 3 feet from the composite article in a room with standard lighting, when the composite article is folded at 90 degrees, both before and after exposure to a propane flame at a distance of 26 mm from the coating and/or exposure to a temperature of about 1200° C. for a period of at least 10 minutes.

13. An aqueous coating composition comprising:
a polyurethane urea resin;
a melamine crosslinker;
a silicone resin; and
a filler, comprising:
a porous glass aggregate; and
a non-glass filler.

14. The aqueous coating composition of claim 13, having a Krebs viscosity of from about 120 Krebs units to about 240 Krebs units, as measured in accordance with ASTM D562-10 using a Krebs Stormer type viscometer with a paddle spindle rotating at 200 RPM at a temperature of 25° C.

15. A method of forming a composite article, comprising:
applying the coating composition of claim 13 to a substrate to form a film; and
curing the film.

16. The method of claim 15, wherein applying the coating composition comprises spraying the coating composition using gravity fed spray equipment and/or pressure fed spray equipment.

17. The aqueous coating composition of claim 13, wherein the silicone resin is present in the aqueous coating composition in an amount of from about 20 wt % to about 35 wt %, based on a total weight of the aqueous coating composition.

18. The aqueous coating composition of claim 13, wherein the weight ratio of the porous glass aggregate to the non-glass filler is from about 2:1 to about 10:1.

19. The aqueous coating composition of claim 13, wherein the porous glass aggregate has a D50 nominal particle dimension of from about 0.3 mm to about 1.2 mm, as measured using a sieve in accordance with ASTM 5861-07 (2017).

20. The aqueous coating composition of claim 18, wherein:
the filler comprises a mineral fiber in an amount of from about 3 wt % to about 7 wt %, based on a total weight of the coating composition;
the silicone resin is present in the aqueous coating composition in an amount of from about 20 wt % to about 35 wt %, based on a total weight of the aqueous coating composition;
the weight ratio of the silicone resin to the polyurethane urea resin is from about 1:3 to about 3:1; and
the porous glass aggregate has a D50 nominal particle dimension of from about 0.3 mm to about 1.2 mm, as measured by as measured using a sieve in accordance with ASTM 5861-07 (2017).
